(19) United States
(12) Patent Application Publication
(10) Pub. No.: US 2012/0134474 A1
(43) Pub. Date: May 31, 2012

(54) HANDSWITCH QUICK CONNECT EXPOSURE CONTROL

(75) Inventors: Christopher Duca, Cape Coral, FL (US); Edward Thieman, Fort Lauderdale, FL (US); Michael Markert, Fort Lauderdale, FL (US)

(73) Assignee: VIRTUAL IMAGING, INC., Deerfield Beach, FL (US)

(21) Appl. No.: 13/300,129

(22) Filed: Nov. 18, 2011

Related U.S. Application Data
(60) Provisional application No. 61/417,318, filed on Nov. 26, 2010.

(51) Int. Cl. H05G 1/38; H05G 1/56

(52) U.S. Cl. 378/96; 378/114

(57) ABSTRACT

A radiation imaging system includes a radiation detector for detecting radiation emitted from a radiation generator; a quick-connect unit configured to activate the radiation generator to initiate radiation emission and to activate the radiation detector to initiate detection of the radiation; and a notification unit included within the quick-connect unit that is configured to notify an operator of a time when the radiation detector is ready to detect the radiation. The quick-connect unit is connectable to the radiation detector and the radiation generator without having to make hardware modifications therein. In an alternate embodiment, the quick-connect unit is a handswitch to be held by an operator, where the notification unit notifies the operator that the radiation detector is ready to detect the radiation, by emitting at least one of a visual signal, a tactile signal and an audible signal.

### CROSS REFERENCE TO RELATED APPLICATIONS

This application claims priority from Provisional Application No. 61/417,318 filed Nov. 26, 2010, the disclosure of which is hereby incorporated by reference herein in its entirety.

### FIELD

The disclosure of this application relates generally to exposure control circuitry for a radiation imaging apparatus, and in particular to a quick-connect handswitch capable of providing timing for exposure control of the imaging apparatus and of providing indication of exposure status.

### BACKGROUND

In the field of diagnostic imaging, a variety of radiation imaging systems is routinely used to generate diagnostic images. A primary consideration in a radiation imaging system is to reduce the dose of radiation to the patient as well as to the operator as much as possible while still achieving diagnostic goals. To that end, diagnostic imaging, such as magnetic resonance, ultrasound, angiography, nuclear medicine and X-ray imaging, has been rapidly moving from analog technologies towards digital substitutes. Digital radiography (DR), for example, is a form of radiation imaging in which a digital sensor, such a semiconductor based flat panel detector (FPD) is used to detect radiation instead of traditional screen/film (S/F) cassettes. DR sensors are rapidly becoming the de facto standard for medical and security imaging as these provide substantial advantages over traditional analog S/F based systems. Not only does digital radiography offer higher resolution and higher quality images with more quantization bits, but it also permits substantially instant acquisition and analysis of captured images.

Notwithstanding its advantages, digital radiography continues to remain one of the last holdouts of the analog-to-digital transition in medical and security imaging technologies. There are several reasons for this, but chief among them is the difficulty of integrating or retrofitting newly designed DR sensors into highly regulated and complex analog systems. For example, manufacturers of medical imaging devices must undergo stringent government clearances to show that a medical imaging device or system is safe and efficient for its intended purpose. Moreover, the integration of any new DR sensor into an already government-cleared system or any modification thereof may also have to undergo government clearance. Accordingly, to meet the need for the improved capabilities offered by DR imaging, while minimizing the impact of the retrofit into existing analog imaging hardware, a number of retrofit solutions have been proposed.

FIG. 1 illustrates a conventional setup of a radiation imaging system 100 that includes a conventional analog x-ray generator system (generator system 130) and a retrofitted DR sensor system (digital system 110). The generator system 130 includes an x-ray generator 131, a tube 132, a generator console 133 and a handswitch 135 operatively connected to the generator console 133. The digital system 110 includes a computer 113 having a monitor 114 and being operatively connected to a digital x-ray detector comprised of a power box 111 and digital sensor 112. An example of the digital sensor 112 is the Canon® digital radiography detector CXDI-50C, CXDI-50G, CXDI-60G or the like.

A typical method of connecting a retrofitable digital system 110 to the analog x-ray generation system 130 involves hardwiring a cable 120 from the power box 111 to a generator room interface 134. Specifically, the generator requires hardwiring to the room interface bucky start and bucky contacts, and timing circuitry. This arrangement synchronizes the digital system 110 with the analog x-ray generation system 130, so that exposure and acquisition can occur under the control of an operator. Specifically, once a patient is properly positioned for imaging, the operator performs an imaging operation by activating control switches in the generator console 133 or at the handswitch 135. Necessarily, hardwiring the cable 120 into the power box 111 and the room interface 134 of the existing analog system 130 requires the modification of existing system hardware. More specifically, the installer must open the generator room interface 134 and the power box 111, so that hardwire connections and additional timing and control circuitry necessary for the synchronization are placed therein.

U.S. patent application publication No.: 2009/0129546, disclosed by Newman et al. (hereafter “Newman”), proposes the installation of a retrofit connection apparatus for adapting the timing sequence of a conventional film-based or computed radiography (CR) x-ray imaging system to enable the use of the imaging system with a retrofitable DR detector. The retrofit connection apparatus includes a mode selector for selecting CR or DR imaging; an interface to communicate with the DR detector; an interface to communicate with an x-ray generator; an interface to receive operating signals input by an operator; and a programmed control logical processor that responds to the signals input by the operator—in accordance to a mode selected by the mode selector. Necessarily, integrating Newman's proposed connection apparatus into an existing radiation imaging system also requires significant modification of existing system hardware, so that each of the required interfaces can achieve its intended purpose. For example, Newman proposes mounting additional hardware onto the operator control console using adhesive material or the like.

In consideration of the foregoing, it is evident that a need remains for a solution that has no impact on existing hardware and requires no modification to the components of an existing radiation imaging system.

### SUMMARY

In accordance with at least one embodiment of the present invention, the instant disclosure is directed to, among other things, a radiation imaging apparatus, comprising: a radiation detector for detecting radiation emitted from a radiation generator; a quick-connect unit configured to activate the radiation generator to initiate radiation emission and to activate the radiation detector to initiate detection of the radiation; and a notification unit included within the quick-connect unit is configured to notify an operator of a time when the radiation detector is ready to detect the radiation. The quick-connect unit is connectable to the radiation detector and the radiation generator without having to make hardware modifications therein. In an alternate embodiment, the quick-connect unit is a handswitch to be held by an operator, where the notification unit notifies the operator that the radiation detector is ready to detect the radiation, by emitting at least one of a visual signal, a tactile signal and an audible signal.

Other modifications and/or advantages of present invention will become readily apparent to those skilled in the art from the following detailed description in reference to the drawings.

### BRIEF DESCRIPTION OF THE DRAWINGS

FIG. 1 illustrates a conventional method of connecting a digital system to an analog radiation generating system.

FIG. 2 illustrates a block diagram of a radiation imaging system including a quick-connect apparatus in accordance with a first embodiment of the present invention.

FIG. 3 illustrates a block diagram of a radiation imaging system including a quick-connect handswitch in accordance with a second embodiment of the present invention.

FIG. 4 is a detailed functional diagram of a quick-connect handswitch in accordance with the second embodiment.

FIG. 5 is an exemplary timing and synchronization diagram in accordance with the embodiments of the present invention.

FIG. 6 is a schematic flowchart of an exemplary process performed by a radiation imaging system under control of the quick-connect apparatus in accordance with the present invention.

### DETAILED DESCRIPTION

In the following description, reference is made to the accompanying drawings which are illustrations of embodiments in which the disclosed invention(s) may be practiced. It is to be understood, however, that those skilled in the art may develop other structural and functional modifications without departing from the novelty and scope of the instant disclosure.

In referring to the description, specific details are set forth in order to provide a thorough understanding of the examples disclosed. In other instances, well-known methods, procedures, components and circuits have not been described in detail as not to unnecessarily lengthen the present disclosure. Some embodiments or diagrams of the present invention may be practiced on a computer system that includes, in general, one or a plurality of processors for processing information and instructions, random access (volatile) memory (RAM) for storing information and instructions, read-only (non-volatile) memory (ROM) for storing static information and instructions, a data storage device such as a magnetic or optical disk and disk drive for storing information and instructions, an optional user output device such as a display device (e.g., a monitor) for displaying information to the computer user, an optional user input device including alphanumeric and function keys (e.g., a keyboard) for communicating information and command selections to the processor, and an optional user input device such as a cursor control device (e.g., a mouse) for communicating user input information and command selections to the processor.

As will be appreciated by those skilled in the art, the present examples may be embodied as a system, method or computer program product. Accordingly, some examples may take the form of an entirely hardware embodiment, or an embodiment combining software and hardware aspects that may all generally be referred herein as a “circuit”, “module” or “system”. Further, some embodiments may take the form of a computer program product embodied in any non-transitory tangible computer-readable medium having computer-usable program code stored therein. For example, some embodiments described below with reference to flowchart illustrations and/or block diagrams of methods, apparatus (systems) and computer program products can be implemented by computer program instructions. The computer program instructions may be stored in computer-readable media that can direct a computer or other programmable data processing apparatus to function in a particular manner, such that the instructions stored in the computer-readable media constitute an article of manufacture including instructions and processes which implement the function/act/step specified in the flowchart and/or block diagram.

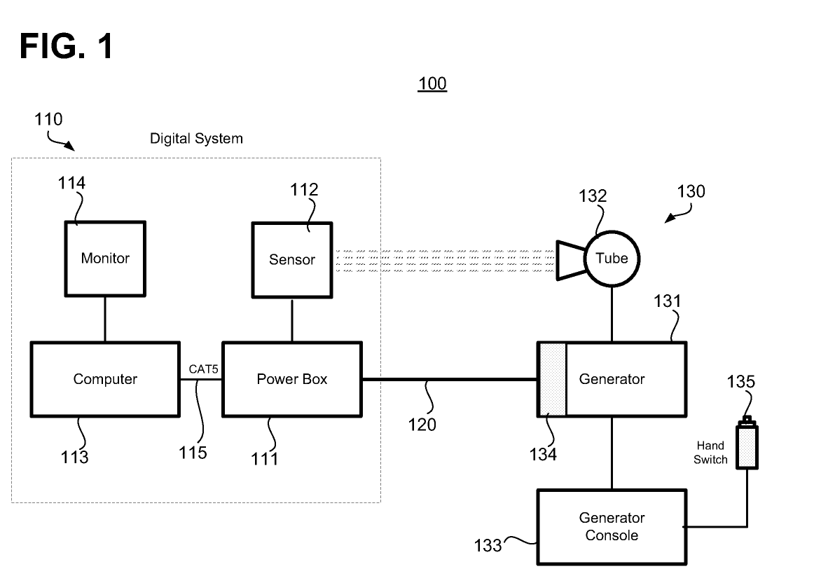

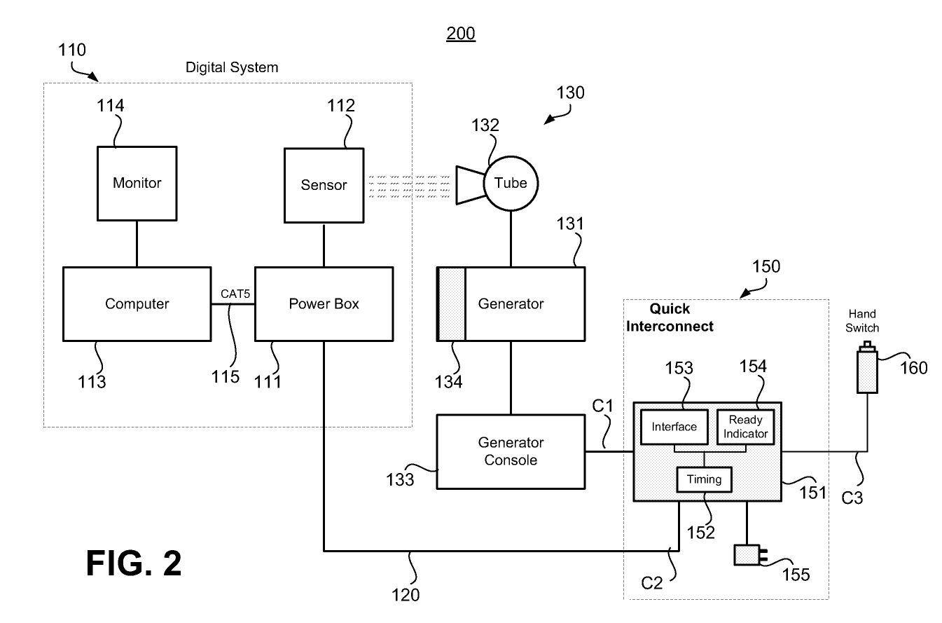

Referring now to the drawings, where like reference numerals refer to like parts, FIG. 2 illustrates a functional diagram of a radiation imaging system 200, in accordance with a first embodiment of the present invention. The radiation imaging system 200 includes a DR digital system 110 and an analog radiation system 130, as previously described in reference to FIG. 1. For this reason, the description of reference numerals already described is omitted to avoid unnecessary duplication. In addition to the already described components, the radiation imaging system 200 includes a quick-connect apparatus 150 and a handswitch 160.

As discussed in the Background section, conventional implementations of a DR system into existing systems necessarily require significant modification of existing system hardware. Modifying an existing system not only is technically challenging and costly, but it also may void costly government clearances of the existing system. The first embodiment of the present invention overcomes such shortcomings, by using the quick-connect apparatus 150. Specifically, the quick-connect apparatus 150 allows for the connection of the digital sensor system 110 to the analog x-ray generator system 130 without having to make hardware modifications in the existing system.

As illustrated in FIG. 2, the quick-connect apparatus 150 eliminates opening the generator console 133 or power box 111 by connecting synchronization and timing circuitry to the existing handswitch connector and to the existing power box connector. Specifically, in the first embodiment, the original (conventional) handswitch 135 is removed and one channel (first channel C1) from the quick-connect apparatus 150 is connected therein. In addition, the existing cable 120 is disconnected from the room interface 134 and is instead connected to a second channel C2 of the quick-connect apparatus 150. A programmable timing circuit 152, an interface connection 153, and a “ready” indicator circuit 154 are provided within a housing 151 of the quick-connect apparatus 150. In addition, an AC to DC converter (transformer) 155 is operatively connected to feed a predetermined direct current voltage (Vdc) to the components contained within housing 151 of quick-connect apparatus 150. In this manner, the quick-connect apparatus 150 ensures that the DR system 110 and the analog generator system 130 remain appropriately synchronized for making x-ray exposures, but without having to make hardware modifications in the existing system.

Continuing to refer to FIG. 2, in the first embodiment, the quick-connect apparatus 150 can be easily implemented as stand alone self-powered device solely contained within the housing 151 with known circuitry contained therein and transformer 155 attached thereto. Components 152 to 154 are feed by transformer 155 and in operative communication with a handswitch 160. Circuitry that can accomplish the basic functions of quick-connect apparatus 150 are the programmable timing circuit 152, the interface circuit 153 and the ready indicator circuit 154 that are operatively connected to each other and configured to communicate with handswitch 160 via cable C3, with generator console 133 via cable C1 and with power box 111 via cable C2, in a manner described more in detail below. However, the circuitry contained within the housing 151 of quick-connect apparatus 150 is not limited to the above described components, but other elements may be added if desired.

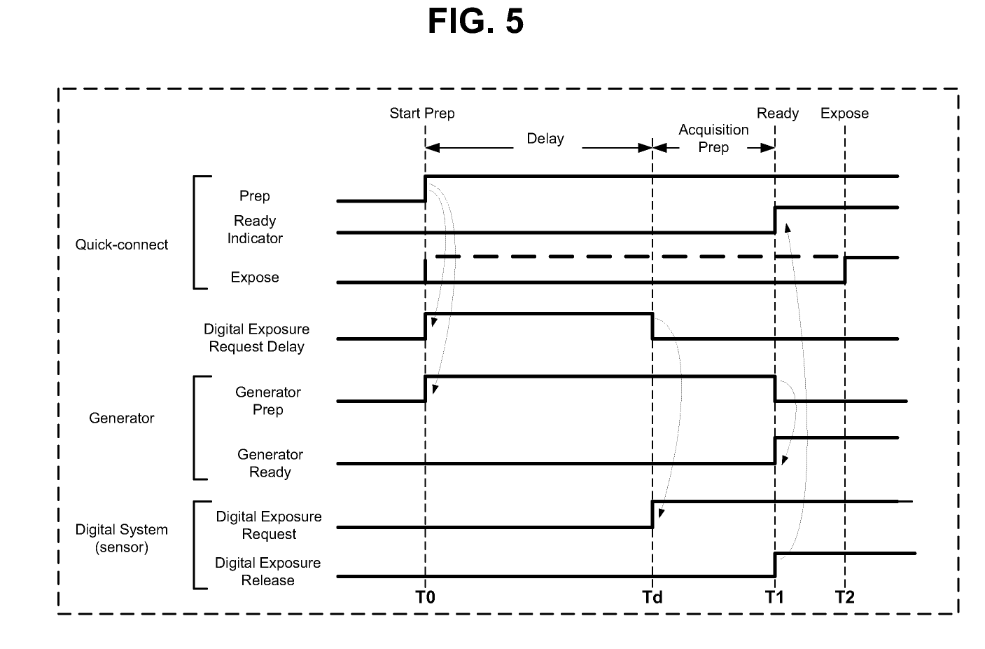

The programmable timing circuit 152 has the function of synchronizing PREP and EXPOSURE signals of the generator system 130 with driving signals of the DR digital system 110, as described in reference to FIG. 5. The interface circuit 153 replaces the functions of the existing room interface 134 and serves to communicate operation signaling between DR system 110, generator system 130 and handswitch 160. In the first embodiment, the handswitch 160 may be a generic two-position handswitch as it is known in the field of x-ray imaging, in which a light emitting diode (LED) or the like may be adapted as the below discussed notification unit. The ready indicator circuit 154 is operatively connected to the timing circuit 152, the interface circuit 153 and the handswitch 160 and has the function of emitting a “ready signal” to a notification unit contained within handswitch 160, as described more in detail below. Indeed, in a case where the notification unit is include within the quick-connect apparatus itself, a pre-existing two-position handswitch (e.g., 135 in FIG. 1) can be used.

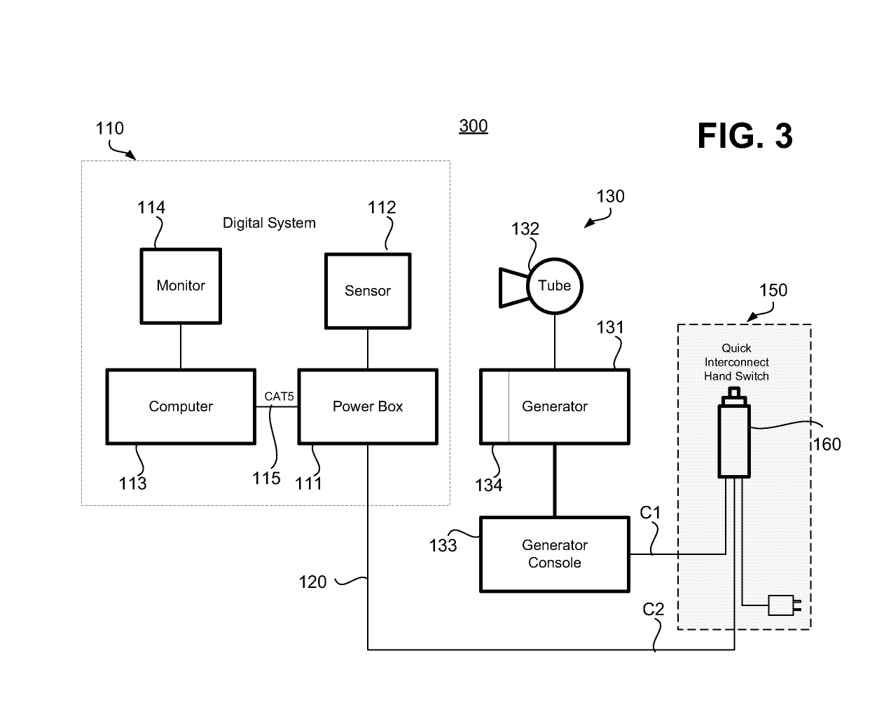

Turning now to FIG. 3, it is illustrated therein a functional diagram of a radiation imaging system 300, in accordance with a second embodiment of the present invention. The radiation imaging system 300 includes a DR digital system 110 and an analog radiation system 130, as previously described in reference to FIGS. 1 and 2. For this reason, the description of reference numerals already described above is omitted to avoid unnecessary duplication. Thus, in addition to the already described components of FIG. 1, the radiation imaging system 300 includes a quick-connect apparatus 150 included within the handswitch 160. More specifically, in the second embodiment, all of the components included within the housing 151 of quick-connect apparatus 150 are now contained with the handswitch 160. Incidentally, in the second embodiment, handswitch 160 is connectable to the generator console 133 via a first channel C1, to the power box 111 via a second channel C2 (connected to existing cable 120 or a connecting port thereof). Similarly to the first embodiment, the quick-connect handswitch 160 is a self-powered package connected to a AC/DC transformer 155.

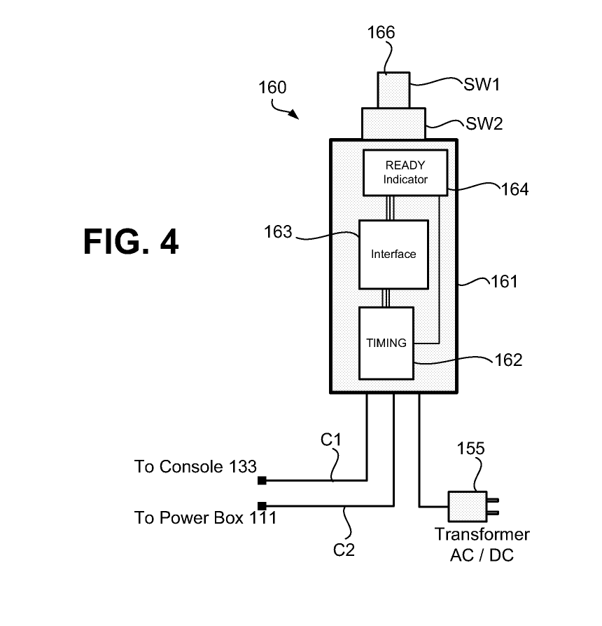

FIG. 4 illustrates an exemplary block diagram of the second embodiment where a timing circuit 162, an interface circuit 163 and a ready indicator circuit 164 are contained within a housing 161 of handswitch 160. The structural configurations and functions thereof of the timing circuit 162, the interface circuit 163 and the ready indicator circuit 164 are preferably the same as the corresponding components referenced by numerals 152 to 154 of the first embodiment described above. In the second embodiment, however, each of the timing circuit 162, the interface circuit 163 and the ready indicator circuit 164 are arranged within the housing 161 of a two-position handswitch. Accordingly, the second embodiment can be implemented as a self-contained quick-connect handswitch (handswitch 160).

As illustrated in FIG. 3, the quick-connect apparatus 150, now contained entirely within handswitch 160 (FIG. 4) eliminates the need for opening the generator console 133 or power box 111 by connecting synchronization and timing circuitry to the existing handswitch connector and to the existing power box connector. Specifically, in the second embodiment, the original (conventional) handswitch is removed and one channel (first channel C1) from the quick-connect handswitch 160 is connected therein. In addition, the existing cable 120 is disconnected from the room interface 134 and is now connected to a second channel C2 of the quick-connect handswitch 160. In order to provide the necessary power to the components 162 to 164 contained within housing 161 of the handswitch 160, the transformer 155 has been connected thereto. However, in alternative embodiments, the transformer 155 may be replaced by an internal or external battery or other type of power source.

As in the first embodiment, the programmable timing circuit 162 has the function of synchronizing PREP and EXPOSURE signals of generator system 130 with driving signals of the DR digital system 110, in the manner described below in reference to FIG. 5. The interface circuit 163 replaces the functions of the existing room interface 134 and serves to communicate operation signaling between DR system 110 and generator system 130. The ready indicator circuit 164 is operatively connected to the timing circuit 162, the interface circuit 163 and a notification unit 166. The notification unit 166 has the function of emitting a “ready signal” to inform an operator of a “ready” status of the DR sensor 112, as described more in detail below.

Specifically, the notification unit notifies an operator of a time when the sensor 112 of DR system 110 is ready to detect radiation from radiation system 130. Here, it should be noted that a notification unit configured to notify an operator of certain feedback condition is known in the art. For example, each of U.S. Pat. No. 7,483,516 and European patent application publication No.: EP 0923275 discloses handswitch devices that include tactile or sound feedback mechanisms can inform an operator of an operation status of an x-ray system.

Indeed, in the field of radiation imaging, it is known that an x-ray generator (generator) must be synchronized with a DR x-ray sensor (detector), so that the generator irradiates the detector at the precise time when the detector is ready to receive radiation. A typical generator requires around 800 milliseconds of preparation time (prep period) to be ready to emit radiation. This prep period is required to boost the rotor (tube) speed for appropriate exposure; accordingly this operation may be referred to as “a radiation preparation operation”. Similarly, the detector requires around 300 milliseconds to be ready (ready period) to detect radiation. This ready period is required, for example, to release the exposure contact once an exposure request is received, or to reset previously charged pixels; accordingly this operation may be referred as “a detection preparation operation”. It is, therefore, desirable to synchronize the generator and the detector, so that exposure (i.e., radiation emission from the generator) begins as close as possible to the time when the detector is ready to detect radiation. In the above-referenced patent application disclosed by Newman, the retrofit connection apparatus uses the programmed control logical processor to control the timing sequence to allow sufficient delay for reset of the DR detector sensing circuitry and timing the integration period of the DR detector to just overlap the period during which x-rays are generated.

Federal safety regulations require that radiation from the X-ray generator be emitted only for the minimum amount of time required to obtain an appropriate image and only at the exact time required (e.g., when a patient is ready and in the appropriate position). To that end, a so called “dead-man” switch must be incorporated into the control circuitry of the X-ray generator. This means that the operator's exposure switch will not permit radiation emission from the generator unless the dead-man switch is activated and held by the operator throughout the exposure operation. The dead-man switch can be implemented in several forms.

In certain arrangements, an operator activates a handswitch (e.g., the above described dead-man switch), whereby the prep period of the generator is started at a certain time T0 and the ready period of the detector starts after a delay period Td has elapsed with respect to time T0. In this manner, the generator can start radiation emission at a certain time T1, which ideally should also be the time at which the generator is “ready”. In other words, a delay circuit is implemented—as described above—to synchronize the generator and the detector so that these can be ready substantially simultaneously.

The problem with the conventional timing delay and circuitry thereof is that the operator does not know exactly when the DR system—in particular the DR sensor—is actually “ready” because often times the detector may take longer than the ready period to be ready. The amount of time in this inaccuracy can be as low as several microseconds to a few milliseconds; however, this inaccuracy in timing may cause that the images detected are not entirely accurate, or more importantly, it may cause that an object or patient be exposed to unnecessary radiation.

As disclosed herein, however, a notification unit is configured to positively and unequivocally inform the operator that the detector (e.g., DR x-ray sensor 112) is indeed ready. In certain arrangements, the notification unit takes the form of a light emitting unit, such as a LED, a laser diode, an optical fiber or the like that illuminates when the DR system 110 is ready to acquire exposure. In other arrangements, the information unit may take the form of a haptic interface (e.g., a vibrating device) in order to take advantage of the tactile sense of the operator. In further arrangements, the information unit may take the form of a sound emitting unit (e.g., a beep, voice announcement or the like). Other forms of feedback may also be suitable. In this manner, the operator can effectively and unequivocally be informed that the detector is ready, and can then initiate exposure at the most appropriate time.

Accordingly, in the first embodiment, the notification unit may be included in the ready indicator circuit 154 and/or the handswitch 160. In the second embodiment, on the other hand, the notification unit 166 may be included only in the handswitch 160 along with all of the other timing and interface components. In this manner, when the programmable timing circuit, the interface circuit and the ready indicator circuit are incorporated within the quick-connect apparatus 150, or more preferably within the handswitch 160, an integrated solution of exposure control and “ready” notification is achieved without having to make hardware modifications in the existing system. In addition, by providing a notification unit in the handswitch or in the quick-connect apparatus, or in both, the operator can receive a positive indication that the DR system 110 is indeed ready to receive radiation from generator system 130. Accordingly, the present solution provides a simple, yet novel compact package which interfaces and synchronizes legacy analog x-ray generators with new DR imaging systems without modifying the generator console or DR power box, thus advantageously simplifying implementation of newer DR systems into conventional analog systems.

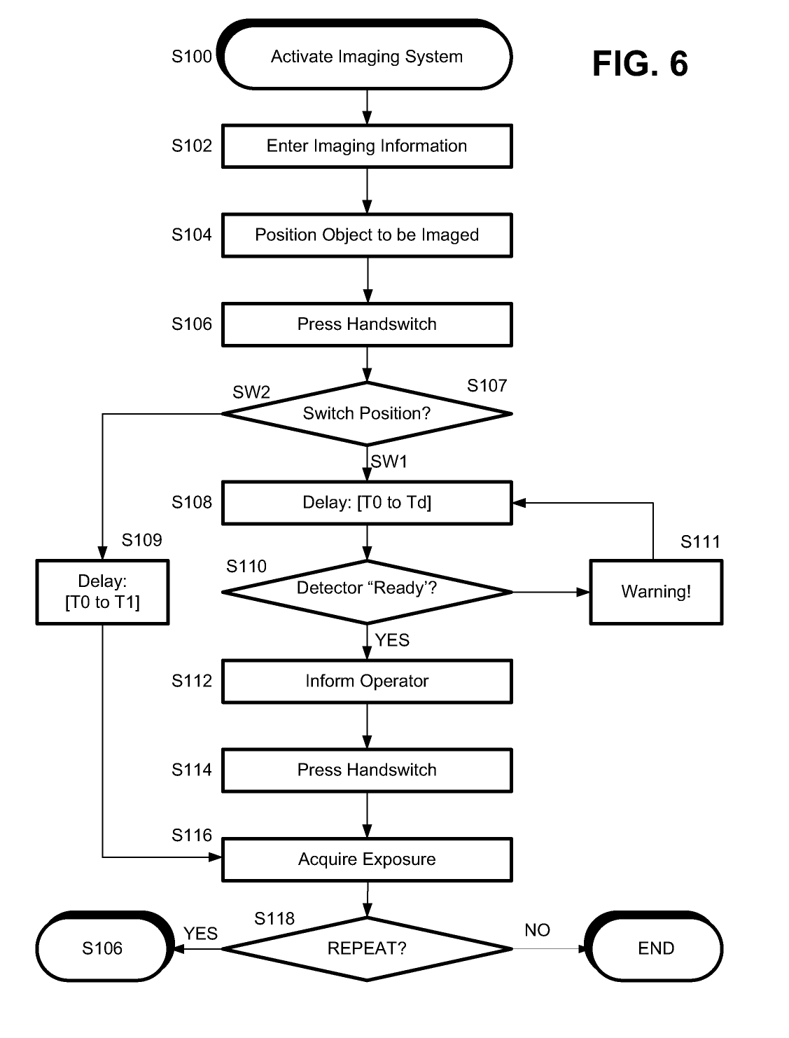

The timing and synchronization operation of the quick-connect apparatus will be next described with reference to the timing diagram of FIG. 5 and the flow process of FIG. 6. The timing diagram of FIG. 5 represents signal timing and synchronization that can be implemented with the programmable timing circuit 152 or 162. The flow process of FIG. 6 represents logic processing that can be implemented with circuitry including the timing circuit 152/162 and the interface circuit 153/163. Alternatively, an additional microprocessor (not shown) can be arranged within the quick-connect apparatus or handswitch, so that the logic of FIG. 6 can be implemented. Initially, the flow process of FIG. 6 starts at some time prior to time T0 of FIG. 5, where an operator activates the radiation imaging system to place it in operative mode, at step S100. Once the radiation imaging system 100 is an operative mode, at step S102, the operator inputs imaging information into the system. For example, the operator may use any known peripheral device (e.g. monitor 114) of computer 113 to enter imaging information into the system. For example, the operator may use a graphical user interface (GUI) to enter image information, such as, patient/object name, identification number, date, time, etc. . . . , and then selects the desired anatomy or object to be imaged.

At step S104, the operator ensures that the object to be imaged (e.g., a human body) is placed in the optimum position for imaging. At step S106, the operator activates the handswitch 160, preferably advancing the two-position switch 166 to a first position SW1. However, in the case that the operator may press the two-position button 166 of handswitch 160 to the second position SW2, the flow process of FIG. 6 can determine whether the handswitch is at position SW1 or SW2, at step S107. If it is determined that only the first position SW1 of the two-position switch 166 has been activated, the flow proceeds to step S108 at time T0. At this time (T0 in FIG. 5), the circuitry within the quick-connect apparatus (/handswitch) generates a Prep signal, which is sent over the first connection C1 to the generator console 133. At substantially the same time, in response to the Prep signal issued from handswitch 160, the generator initiates a Generator Prep operation (Generator Prep high in FIG. 5). As discussed above, the generator PREP operation is necessary for the x-ray tube rotor to accelerate until a steady-state speed appropriate for generating the desired radiation energy is achieved. In addition, still at the same time T0, a Digital Exposure Request Delay (delay signal) is issued to the DR power box 111. The delay is for a period equal to the Generator Prep time minus the Detector Prep time. In the example described above, the delay period is 500 ms, which is equal to Generator Prep time (800 ms) minus the detector acquisition prep time (300 ms).

During the delay period, at step S108, the flow process of FIG. 6, stops/waits until the delay period elapses. At time Td, the timing circuit sends the Digital Exposure Request signal to the Digital system 110. Meanwhile, the Generator Prep operation continues. That is, from Td to T1, the tube rotor of the generator system 130 continues to accelerate to achieve the proper speed. After the delay period and after a predetermined detector Acquisition Prep time have elapsed (i.e., at time T1 in FIG. 5), the digital system 110 is essentially ready for acquisition and closes a Digital Exposure Release relay. At the end of the delay period and detector Acquisition prep time period, that is—at time T1 in FIG. 5, the flow process of FIG. 6 advances to Step S110.

At this time (T1), the generator rotor is now at the proper speed (Generator Ready signal high) and the Digital system has been released for exposure (Digital Exposure Release high); that is, both digital system 110 and generator system 130 are ready for exposure. Nevertheless, the flow process of FIG. 6 stays in step S110 until a detector “ready” signal is received. More specifically, the Digital Exposure Release signal causes that a ready signal be sent from digital system 110 to the ready indicator circuit 154 or 164, so that the notification unit can notify the operator of the ready status of the digital system, by emitting the detector ready signal.

Accordingly, at step S110 of FIG. 6, once a positive confirmation is received by the operator that the digital system 110 is ready for exposure (YES in S110) the flow process advances to step S111. At step S111, the notification unit is activated. That is, in response to the ready signal received from the digital system 110, the quick-connect apparatus/handswitch ready indicator (notification unit) is activated, thus alerting the operator that the digital system 110—and more specifically the sensor 112—is ready for exposure.

In other words, once the operator is informed of the readiness of the digital system (S112 in FIG. 6), substantially at time T1 or any time thereafter (e.g., at time T2), an exposure can occur only when the handswitch is depressed completely by the operator to advance to the second position SW2 (S114 in FIG. 6). Once the operator advances the handswitch 160 to second position SW2, the process of FIG. 6 advances to steps S114 to acquire an exposure, and subsequently to step S118 where a decision is made whether the imaging operation should be repeated (YES at S118) or no (NO at S118). If the decision is negative, the process ends, otherwise the process returns to step S106.

Returning to step S110, however, if after a predetermined period (e.g., after the delay period [T0 to Td] plus the Acquisition prep period [Td to T1]) has elapsed and the ready signal is not received from the digital system 110 (NO at S110), the flow process of FIG. 6 can issue a warning at step S111 and continue to wait by returning to S108. For example, instead of emitting a “ready” signal (e.g., a green light or a coded beep) through the ready indicator or notification unit of handswitch 160, the system could emit a warning signal (e.g. a red light or a different coded beep) through the ready indicator of handswitch 160. In this manner, the quick-connect apparatus disclosed herein, in addition to being able to inform the operator of a “ready for exposure status” of the digital system, it can also inform the operator of a “non-ready for exposure status” of the digital system. Advantageously, for example, the “non-ready for exposure” status signal can warn the operator of certain anomaly or malfunction in either the digital system 110 or the generator system 110.

Moreover, in a case where the operator may inadvertently or unintentionally press the two-position switch 166 to the second position SW2, the logic of the flow diagram of FIG. 6 can advantageously prevent that a patient or the like be unnecessarily exposed to radiation. Specifically, even if the pushbutton (two-position switch 166) of handswitch 160 is pressed fully to position SW2, logic circuitry of the quick-connect apparatus can be interlocked to prevent that the exposure can occur before the Digital Exposure Release. As illustrated in FIG. 6, if at step S107 it is determined that the switch 166 is at position SW2, the flow proceeds to step S109 where a delay equal to the Generator Prep time (i.e. delay equal to time [T0 to T1] is implemented. Specifically, in FIG. 5, even if assuming that the Expose signal becomes high at time T0 (dashed line from T0 to T2), the Generator Ready signal does not go high until after the generator prep time (i.e., delay plus acquisition prep time) has elapsed. Thus, in case that the pushbutton or switch 166 of the handswitch 160 is fully pressed at once, the worst case scenario may be that the exposure occurs at exactly the same time when the Digital Exposure Release signal and the Generator Ready signal are issued (i.e., at T1), rather than at T2. In this manner the quick-connect apparatus of first embodiment or the quick-connect handswitch of the second embodiment can advantageously ensure that the digital system is ready to acquire exposure from the generator system even if the operator activates the PREP and EXPOSE signals at the same time.

While the present invention has been described with reference to exemplary embodiments, persons having ordinary skill in the art will appreciate that many variations are possible within the scope of the examples described herein. Thus, should be understood that structural and functional modifications may be made without departing from the scope of the following claims to which it should be accorded the broadest reasonable interpretation.

What is claimed is:

1. A radiation imaging apparatus, comprising:
a radiation detector for detecting radiation emitted from a radiation generator;
a trigger unit configured to activate said radiation generator to initiate radiation emission and to activate said radiation detector to initiate detection of said radiation; and
a notification unit configured to notify an operator of a time when the radiation detector is ready to detect said radiation,
wherein the notification unit is included within the trigger unit.

2. The radiation imaging apparatus according to claim 1, wherein the trigger unit includes a hand switch.

3. The radiation imaging apparatus according to claim 1, wherein the notification unit includes a light emitting unit.

4. The radiation imaging apparatus according to claim 1, further comprising a timing control circuit configured to control said radiation generator and said radiation detector.

5. The radiation imaging apparatus according to claim 4, wherein said trigger unit is operatively connected to said timing control circuit, and
wherein said timing control circuit controls said radiation generator such that the radiation generator initiates a radiation preparation operation at a time T0 in response to said trigger unit being operated by an operator, and initiates said radiation emission at a predetermined time T1 after the trigger unit is operated.

6. The radiation imaging apparatus according to claim 5, wherein the timing control circuit controls said radiation detector such that the radiation detector initiates a detection preparation operation after a delay period Td with respect to said time T0, and initiates a radiation detection operation at substantially said predetermined time T1.

7. The radiation imaging apparatus according to claim 6, wherein said notification unit notifies the operator that the radiation detector is ready to detect said radiation at said predetermined time T1.

8. The radiation imaging apparatus according to claim 4, wherein said timing circuit is incorporated within said trigger unit.

9. The radiation imaging apparatus according to claim 8, wherein said trigger unit includes a prep switch and an exposure switch, and
wherein, in response to said operator operating said trigger unit, said prep switch is activated at said time T0 and said exposure switch is activated at substantially said time T1.

10. The radiation imaging apparatus according to claim 9, wherein said prep switch is operatively connected to the timing control circuit, and
wherein said timing control circuit controls said radiation generator to initiate said radiation preparation operation at said time T0 and controls said radiation detector to initiate said radiation preparation operation after said time delay Td in response to said prep switch being activated.

11. The radiation imaging apparatus according to claim 9, wherein said exposure switch is operatively connected to the timing control circuit, and
wherein said timing control circuit controls said radiation detector to initiate said radiation emission and controls said radiation detector to initiated said radiation detection in response to said exposure switch being activated at substantially said time T1.
